(19) United States
(12) Patent Application Publication
(10) Pub. No.: US 2003/0222128 A1
(43) Pub. Date: Dec. 4, 2003

(54) Picture postcard mailer with rigid frame and stand

(76) Inventors: Catherine Parks Snider, Oregon, WI (US); Kimberly J. Evans, Madison, WI (US)

Correspondence Address: DEWITT ROSS & STEVENS S.C., 8000 EXCELSIOR DR, SUITE 401, MADISON, WI, 53717-1914, US

(21) Appl. No.: 10/446,249

(22) Filed: May 28, 2003

Related U.S. Application Data
(60) Provisional application No. 60/383,858, filed on May 29, 2002.

(51) Int. Cl. B42D 15/00

(52) U.S. Cl. 229/92.8

(57) ABSTRACT

Disclosed is a picture postcard mailer for mailing and framing photographs and the like. The mailer includes a frame portion defining an aperture therethrough and further defining a cross-sectional pocket therein. The cross-sectional pocket is dimensioned and configured to retain an image within it such that the image is visible through the aperture. A stand portion is connected to the frame portion and is movable between a retracted position and an extended position. A detachable writing surface is attached to a peripheral edge of the frame portion. Means for maintaining the stand portion in the extended position are provided so that the postcard mailer can be displayed when received.

### CROSS-REFERENCE TO RELATED APPLICATIONS

Priority is hereby claimed to provisional application Ser. No. 60/383,858, filed May 29, 2002, and incorporated by reference herein.

### FIELD OF THE INVENTION

The invention is directed to a picture postcard mailer that can also double as a permanent framing member for pictures, photographs, and the like.

### BRIEF DESCRIPTION OF THE DRAWINGS

FIG. 1 is a rear perspective view of an embodiment of a picture postcard mailer according to the present invention, with the stand extended.

FIG. 2 is a top plan view of the embodiment shown in FIG. 1, with the stand retracted and the entire mailer laid flat.

FIG. 3 is a front elevation view of the embodiment shown in FIG. 1

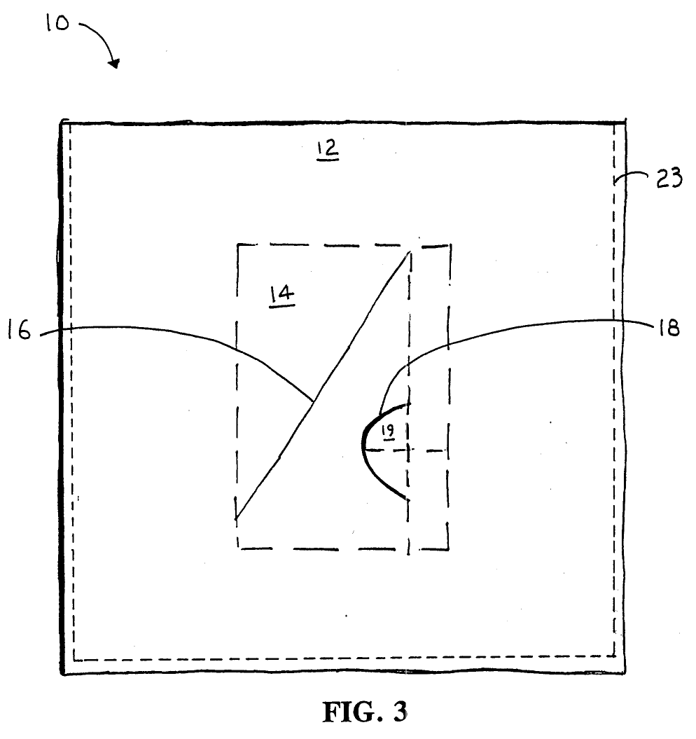

FIG. 4 is a front perspective view of a picture postcard mailer according to the present invention, with the stand retracted.

### DETAILED DESCRIPTION OF THE INVENTION

A first embodiment of the invention is directed to a picture postcard mailer comprising a frame portion that defines an aperture therethrough. The frame portion further defines a cross-sectional pocket therein, the cross-sectional pocket being dimensioned and configured to retain an image therein such that the image is visible through the aperture. The postcard further comprises a stand portion connected to the frame portion and movable between a retracted position and an extended position and a detachable writing surface attached to a peripheral edge of the frame portion. The postcard also includes means for maintaining the stand portion in the extended position.

The postcard mailer is preferably fabricated from paper-based materials. It is also preferred that the postcard mailer be dimensioned and configured to fit within a mailing envelope of corresponding dimensions.

A second embodiment of the invention is a picture postcard mailer comprising a frame portion as defined in the first embodiment, and a detachable writing surface attached to a peripheral edge of the frame portion and detachable from the frame portion, the writing surface being movable between a retracted position and an extended position, wherein in the retracted position, the writing surface contacts the frame portion in face-to-face orientation. The second embodiment of the invention further comprises a stand portion connected to the frame portion and movable between a retracted position and an extended position, wherein the stand portion defines an arcuate notch. Lastly, the postcard mailer of the second embodiment includes a retractable tab disposed within the arcuate notch defined by time sad portion, the tab movable between a retracted position substantially co-planar with the frame portion, and an extended position substantially perpendicular to the plane of the stand portion, and wherein when in the extended position the tab contacts a peripheral edge of the arcuate notch.

A third embodiment of the invention comprises picture postcard mailer as described in the first two embodiments, wherein when the writing surface is in the retracted position, the writing surface contacts the frame portion in face-to-face orientation, with the stand portion and the retractable tab disposed between the writing surface and the frame portion.

Referring now to the drawing figures, where the same numbers are used throughout the various views to designate the same elements, the invention is a picture postcard mailer 10, having a frame portion 12 defining an aperture 14, and stand portion 16, means for maintaining the stand portion in an extended position 18, a detachable writing surface 20, and a cross-sectional pocket 22 defined within the frame portion.

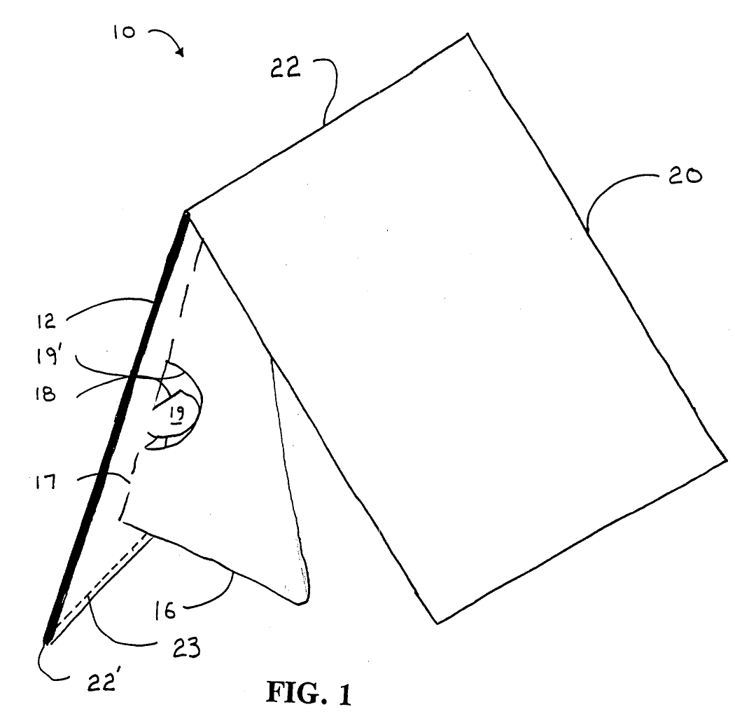

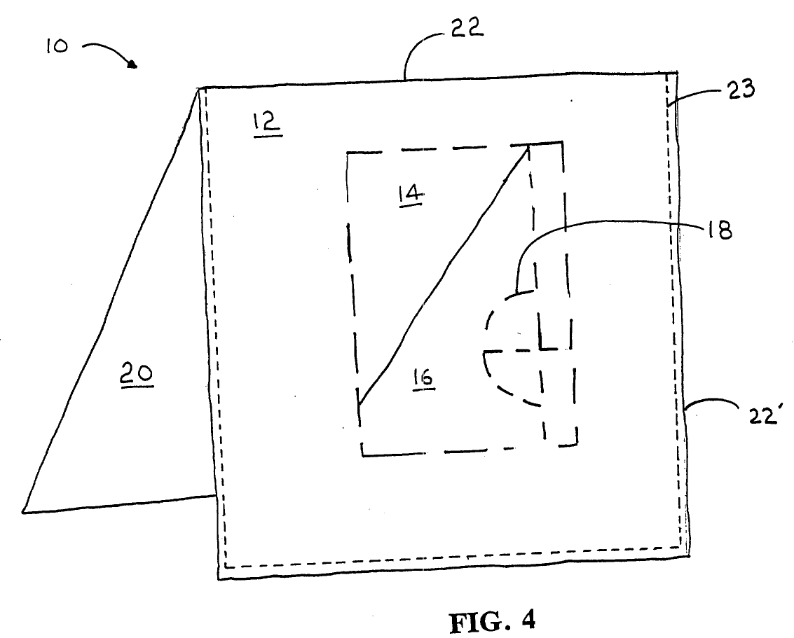

Referring now specifically to the perspective renderings shown in FIGS. 1 and 4, the picture postcard mailer 10 includes a rigid frame portion 12, that defines an open area 14 (see FIG. 4). Additionally, within the frame is defined a cross-sectional cavity 23 (shown in broken lines) that is accessed via an opening 22 or 22′ in the sidewall of the frame portion 12. In this fashion, a picture, photograph, or other flat image is slid into the cross-sectional cavity via opening 22 or 22′, and the image thus appears within the aperture 14. Thus, the frame portion 12 of mailer will surround an image, in the same fashion as a conventional picture frame, with the displayed image resting within, and held in place by, the cross-sectional cavity.

Note that as shown in the drawing figures, the frame portion 12 is roughly square. This is for purposes of brevity only. The frame portion may take any desired shape, such as triangular, rectangular, pentagonal, hexagonal (i.e., any polygon), circular, oval, etc. Likewise, the aperture 14 is also shown as a rectangle. The frame portion 12 may define an aperture 14 of any shape or dimension, without limitation.

It is preferred that the frame portion 12 be made from a suitably stiff, paper-based material, such as heavy-stock paper, paper board, Bristol board, card board, matting board, and the like. The frame portion 12, may also be made from wood, metal, plastic, etc. The frame portion 12 may also be made by a composite or laminate of two or more layers of these materials (either the same or different materials), with the cross-sectional pocket 23 being defined between two adjacent layers. Alternatively, where the frame portion is monolithic, the cross-sectional pocket is simply a void defined within the frame member itself.

The cross-sectional pocket 23 defined within the frame portion may be accessed from any point along the perimeter of the frame portion 12. For example, as shown in FIG. 4, the cross-section pocket is accessed from the top via opening 22. In FIG. 1, however, the cross-sectional pocket 23 is accessed from the side via opening 22′ or from the top 22. In short, the opening to access the cross-sectional pocket may be located at any line (or curve) along the perimeter of the frame portion 12.

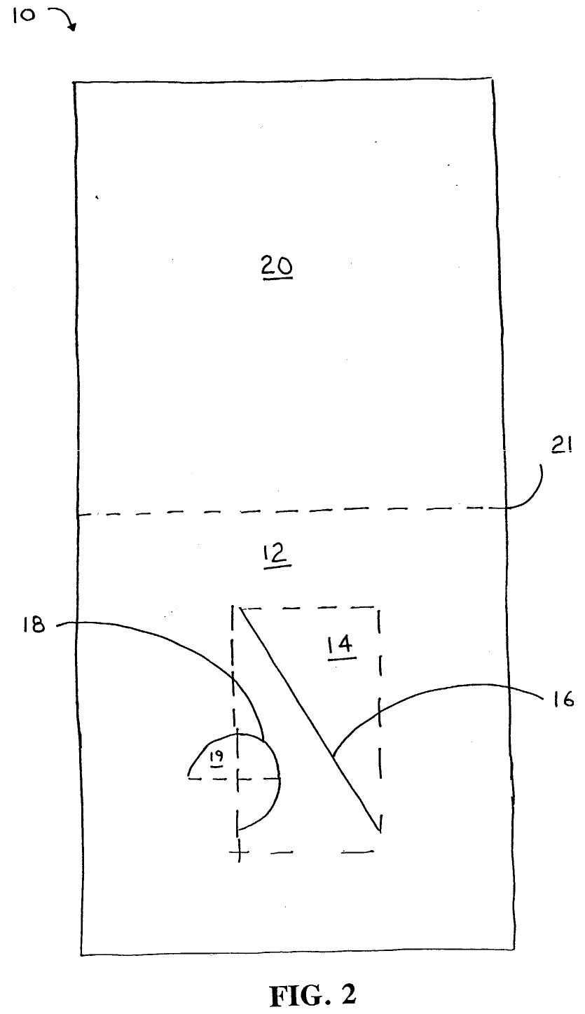

A writing surface 20 is attached to the frame portion 12 at folded joint 21. See FIG. 2. The joint 21 may be perforated to allow easy removal of the writing surface 20. The writing surface may be of any shape or dimension, either the same as or different from the frame portion 12. The preferred embodiment is shown in the figures, where the outer perimeter of the writing surface 20 matches that of the frame portion 12. The joint 21 allows the writing surface to fold flat (in face-to-face orientation) with the frame portion 12, thereby enabling the entire picture postcard 10 to be inserted into an envelope and mailed.

A key aspect of the invention is the stand portion 16, and the means for maintaining the stand portion in an extended position 18. The stand portion 16 is attached to one of the inner perimeters of the frame portion 12 (i.e., the perimeter that defines the aperture 14). See FIG. 1, reference 17. The stand portion 16 folds outwardly from rear face of the frame portion 12, thereby serving as a stand to hold the frame portion in a substantially upright position. The means for maintaining the stand portion in an extended position 18 takes the form of a retractable tab that extends in a plane roughly perpendicular to the plane of the stand portion 16, and which abuts the stand portion 18. As shown in FIG. 1, the means 18 comprises a retractable tab or flange 19 that is movable within an arcuate notch or hollow 19′ in the stand portion. When extended, the tab 19 contacts the peripheral edge of the notch 19′, thereby holding the stand 16 in an extended position via friction. The tab 19 may also include a centrally located notch (not shown) to aid in maintaining the stand 16 in the extended position.

In operation, an image to be displayed is placed within cross-sectional pocket 23, via opening 22 or 22′. If a message is to be sent along with the image, the message may be written on writing surface 20. The picture postcard mailer can then be sent to its intended recipient via post. The recipient may, if desired, remove the writing surface 20, by tearing along joint 21 to separate the writing surface from the frame portion. To display the image held within the frame portion, the stand 16 is extended and the tab 19 is also extended to hold the stand 16 in place. The frame portion 16 will thus be held in substantially upright position, as shown in FIGS. 1 and 4.

What is claimed is:

1. A picture postcard mailer comprising:
a frame portion defining an aperture therethrough and further defining a cross-sectional pocket therein, the cross-sectional pocket being dimensioned and configured to retain an image therein such that the image is visible through the aperture;
a stand portion connected to the frame portion and movable between a retracted position and an extended position;
a detachable writing surface attached to a peripheral edge of the frame portion and detachable from the frame portion; and
means for maintaining the stand portion in the extended position.

2. The picture postcard mailer of claim 1, wherein the frame portion, the stand portion, the writing surface, and the means for maintaining the stand portion in the extended position are fabricated from paper-based material.

3. The picture postcard mailer of claim 1, wherein the means for maintaining the stand portion in the extended position comprises a retractable tab disposed within the arcuate notch defined by the stand portion, the tab movable between a retracted position substantially co-planar with the frame portion, and an extended position substantially perpendicular to the plane of the stand portion, and wherein when in the extended position the tab contacts a peripheral edge of the arcuate notch.

4. The picture poscard mailer of claim 1, wherein the writing surface is movable between a retracted position and an extended position, wherein in the retracted position, the writing surface contacts the frame portion in face-to-face orientation.

5. The picture postcard mailer of claim 1, wherein the writing surface is movable between a retracted position and an extended position, wherein in the retracted position, the writing surface contacts the frame portion in face-to-face orientation, with the means for maintaining the stand portion in the extended position disposed between the writing surface and the frame portion.

6. A picture postcard mailer comprising:
a frame portion defining an aperture therethrough and further defining a cross-sectional pocket therein, the cross-sectional pocket being dimensioned and configured to retain an image therein such that the image is visible through the aperture;
a detachable writing surface attached to a peripheral edge of the frame portion and detachable from the frame portion, the writing surface being movable between a retracted position and an extended position, wherein in the retracted position, the writing surface contacts the frame portion in face-to-face orientation;
a stand portion connected to the frame portion and movable between a retracted position and an extended position, wherein the stand portion defines an arcuate notch; and
a retractable tab disposed within the arcuate notch defined by the stand portion, the tab movable between a retracted position substantially co-planar with the frame portion, and an extended position substantially perpendicular to the plane of the stand portion, and wherein when in the extended position the tab contacts a peripheral edge of the arcuate notch.

7. The picture postcard mailer of claim 6, wherein the frame portion, the stand portion, the writing surface, and the retractable tab are fabricated from paper-based material.

8. The picture postcard mailer of claim 6, wherein when the writing surface is in the retracted position, the writing surface contacts the frame portion in face-to-face orientation, with the stand portion and the retractable tab disposed between the writing surface and the frame portion.

9. A picture postcard mailer comprising:
a frame portion defining an aperture therethrough and further defining a cross-sectional pocket therein, the cross-sectional pocket being dimensioned and configured to retain an image therein such that the image is visible through the aperture;
a detachable writing surface attached to a peripheral edge of the frame portion and detachable from the frame portion, the writing surface being movable between a retracted position and an extended position, wherein in the retracted position, the writing surface contacts the frame portion in face-to-face orientation;
a stand portion connected to the frame portion and movable between a retracted position and an extended position, wherein the stand portion defines an arcuate notch;
a retractable tab disposed within the arcuate notch defined by the stand portion, the tab movable between a retracted position substantially co-planar with the frame portion, and an extended position substantially perpendicular to the plane of the stand portion, and wherein when in the extended position the tab contacts a peripheral edge of the arcuate notch; and
wherein when the writing surface is in the retracted position, the writing surface contacts the frame portion in face-to-face orientation, with the stand portion and the retractable tab disposed between the writing surface and the frame portion.

10. The picture postcard mailer of claim 9, wherein the frame portion, the stand portion, the writing surface, and the retractable tab are fabricated from paper-based material.
